(19) United States
(12) Patent Application Publication
(10) Pub. No.: US 2014/0035181 A1
(43) Pub. Date: Feb. 6, 2014

(54) SYSTEM FOR SURFACE PROFILING OF POURED CONCRETE SLABS

(71) Applicant: Antonio Pantano, West Heidelberg (AU)

(72) Inventor: Antonio Pantano, West Heidelberg (AU)

(73) Assignee: PANTANO INVESTMENTS PTY LTD., West Heidelberg, Victoria (AU)

(21) Appl. No.: 14/111,387

(22) PCT Filed: Apr. 11, 2012
(86) PCT No.: PCT/AU2012/000373

§ 371 Date: Oct. 11, 2013

(30) Foreign Application Priority Data
Apr. 12, 2011 (AU) 2011901376

(51) Int. Cl. B28B 7/02; B29D 99/00

(52) U.S. Cl. CPC B28B 7/02; B29D 99/001
USPC 264/35; 249/98

(57) ABSTRACT

Apparatus for creating a step or break in level of a poured concrete building slab, said apparatus comprising a length of section of suitable height and closed or open cross-sectional shape supported upon a plurality of discrete chairs which are, in turn, fixed to supporting formwork by suitable fastenings; said chairs being unitary or comprising height-adjustable elements; said section providing level references to which the surfaces of the higher and lower parts of said concrete slab are finished and acting as a riser between the two said surfaces; said section and said chairs being left in place in said concrete slab following its curing.

This invention relates generally to the provision, as part of the building construction process, of sills or hobs for the fixing of windows, curtain walls and the like or the provision of level changes in cast-in-situ concrete slabs. More particularly, it relates to moulds for the casting of such sills or hobs or the provision of level changes made integrally with cast in-situ concrete building slabs.

Particularly in the construction of multi-storey buildings, it is common to provide raised sills or hobs of some form to cast in-situ concrete slabs. Such sills or hobs act as supports for building elements such as window frames, curtain wall panels and the like, providing a watertight barrier beneath such building elements to prevent the ingress of rain water and condensation. Said building elements may incorporate lower frames or sills that bear directly upon and are sealed to a supporting surface such as a cast in-situ concrete slab. These commonly take the form of simple or complex metal sections or solid timber sections. In other applications, separate sills or hobs of similar form are sealing fixed to a said supporting surface and said building elements are fixed to and supported by said sills or hobs. In yet other applications, concrete sills or hobs are formed on said cast in-situ concrete slabs to support said window frames, curtain wall panels and the like. In these applications, long box moulds which are more or less open at the top and bottom are fixed to concrete slabs in appropriate positions, filled with concrete and the concrete allowed to cure. Said sills or hobs are then waterproofed appropriately and said building elements then fixed to them. The separate forming of said sills or hobs on cast in-situ concrete slabs is inefficient and time consuming, requiring the re-attendance of several building trades personnel to a building site to accurately measure up and fix said moulds in position and then to fill them with concrete. Additionally, irregularities in the trowelled surfaces of said cast in-situ concrete slabs may require the removal of concrete in order for said moulds to be set at the correct level. When it is considered that a multi-storey building may require several thousand lineal metres of such sills or hobs, the magnitude of the inefficiency and loss of time will be appreciated. Similarly, many situations exist in the construction industry in which steps or level changes are required in concrete slabs. Normally, these are provided by the construction of appropriate formwork. Not only is the construction of formwork a time-consuming process requiring the services of skilled personnel hut, after curing of a concrete slab, the formwork must be stripped out and discarded, thereby incurring further expenditure of labour and loss of value.

The object of the present invention is to provide a system that permits installation of sill or hob forming moulds or devices for the forming of level changes to be integrated into the process of fixing steel reinforcement preliminary to the pouring of concrete slabs, and with the process of filling said sill or hob moulds and the making of said level changes being integrated into the process of in-situ casting of concrete building slabs.

According to the present invention, sill or hob moulds in the form of long boxes more or less open at the top and bottom are installed during the process of installing reinforcing bar. Said moulds are supported from formwork upon a row of discrete chairs which permit the height of said moulds to be adjusted such that their lower edges are set at the intended surface level of the finally cast slab. Fabricated short mould sections are used to join straight runs of said moulds end to end and at directional changes through angles of 90°, 45° or angles of other magnitude. During casting of the parent concrete building slab, said moulds are simultaneously filled with concrete and trowelled off to a level surface. The concrete of the sill or hob so created is thus integral with that of said concrete building slab and is thus much less prone to water infiltration. Various methods are provided to positively prevent water infiltration. Said moulds are made in a variety of cross-sectional shapes and different methods are provided for attaching them to said chairs and adjusting their heights. Provision is made for said sill or hob moulds to be made regularly curved to different radii or in other irregular alignments. Similarly, level changes in cast in-situ concrete slabs are made by supporting upon a row of discrete chairs a length of suitable section, the upper part of a stepped concrete surface then being formed more or less level with the upper edge of the section and the lower part of the stepped concrete surface being formed more or less level with the lower edge of the section, the section serving a retaining function until said concrete has cured. Wherever possible, standard moulds for the making of said sills or hobs are employed as said section. In both cases, said sill or hob moulds and said section are left in place in said concrete slab.

The various aspects of the present invention will be more readily understood by reference to the following description of preferred embodiments given in relation to the accompanying drawings in which:

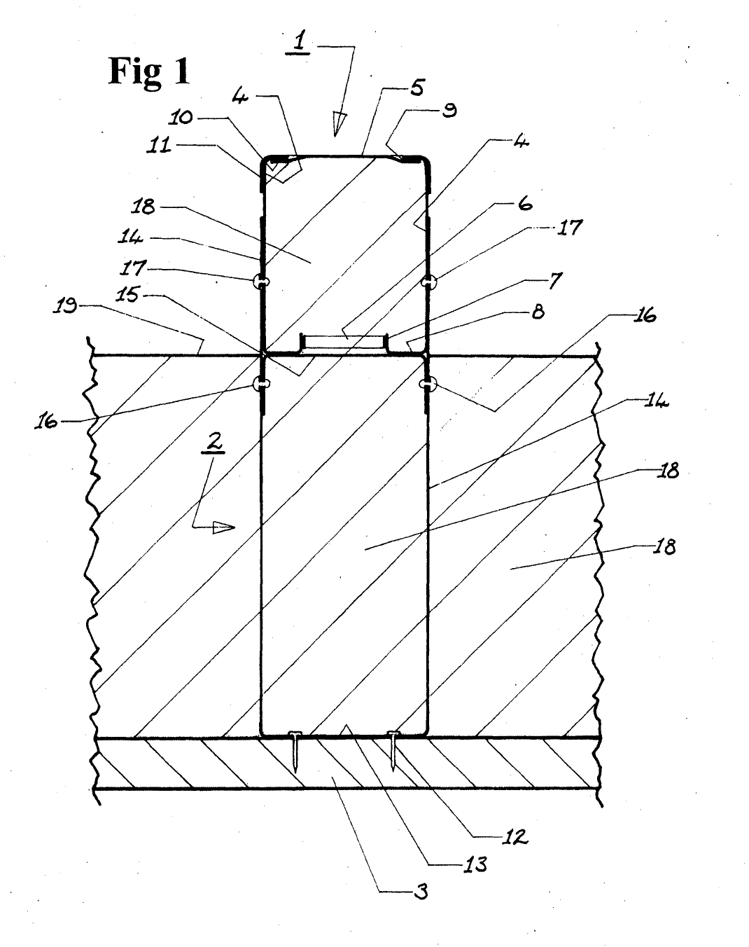

FIG. 1 is a transverse cross-sectional view of a sill or hob mould supported on a chair fixed to formwork, the mould filled with concrete and the concrete building slab cast beneath it;

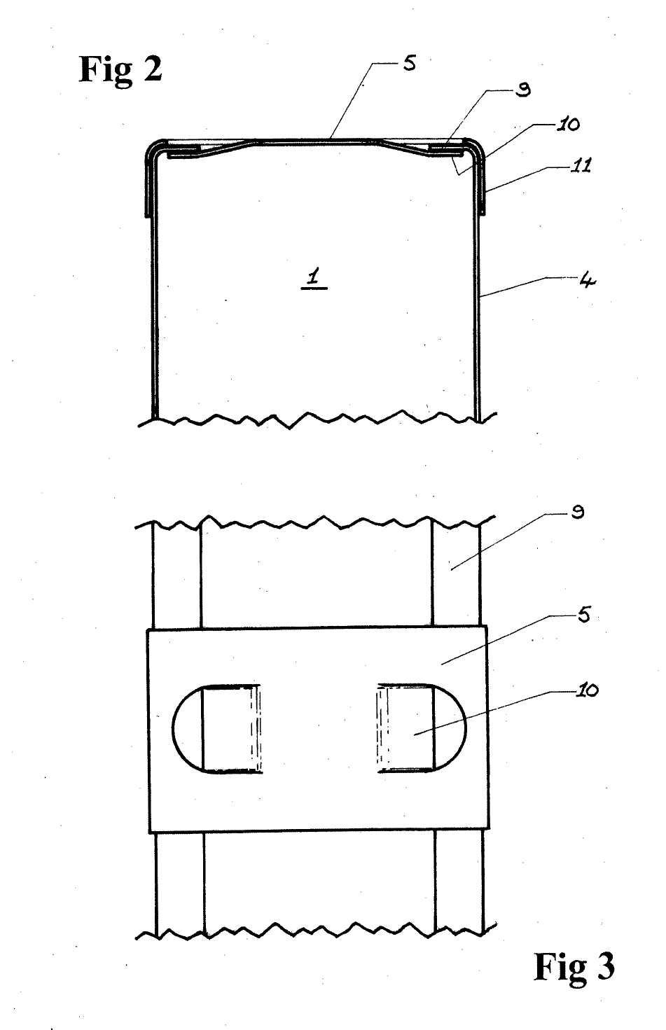

FIG. 2 is a fragmentary transverse cross-sectional view of the upper part of one embodiment of said sill or hob mould;

FIG. 3 is a view from above of said sill or hob mould of FIG. 2;

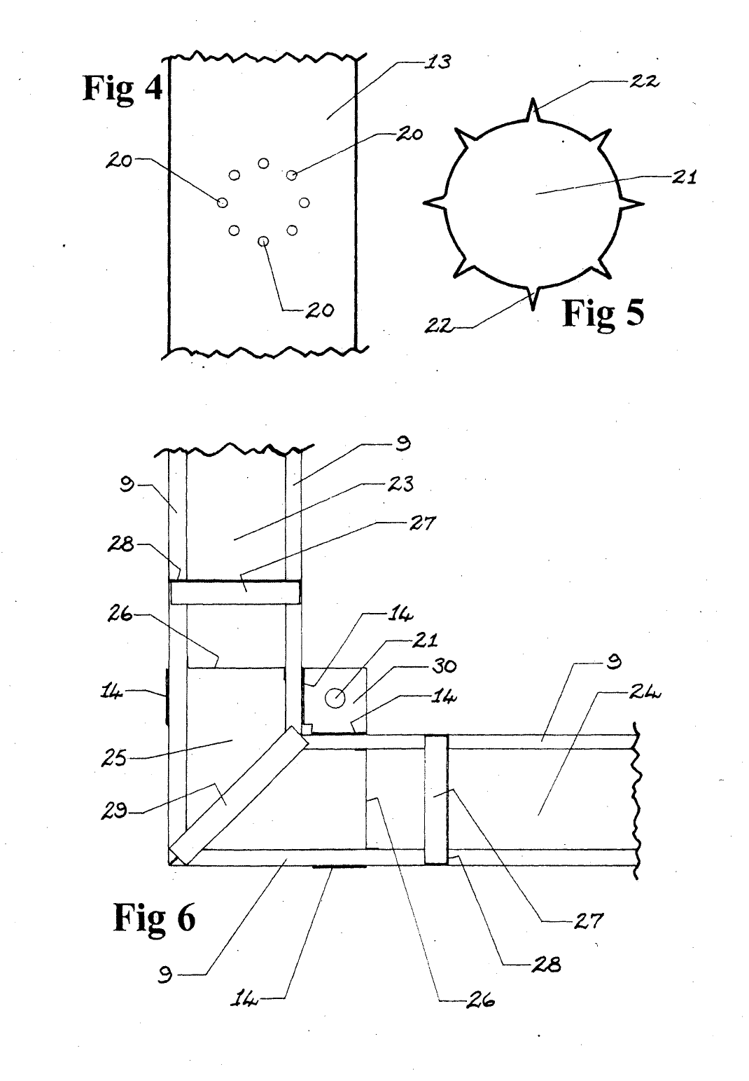

FIG. 4 is a fragmentary view from above of one embodiment of the transverse bottom part of a chair of the present invention;

FIG. 5 is a fixing disk employed with chairs of the embodiment depicted in FIG. 4;

FIG. 6 is a view from above of a 90° corner join straight runs of said sill or hob mould;

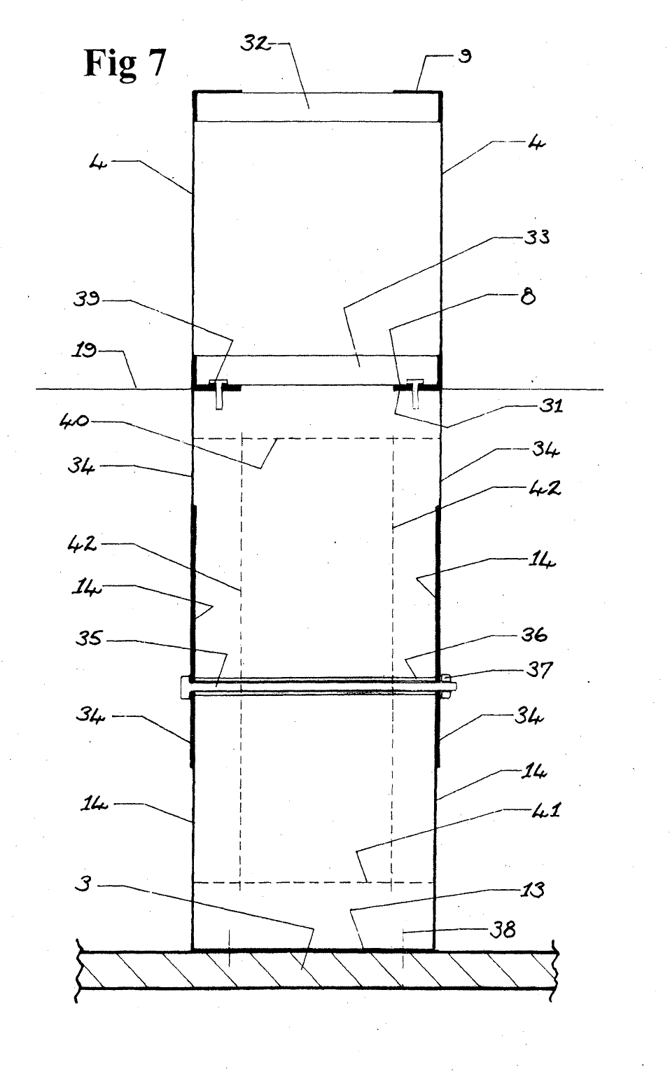

FIG. 7 is a transverse cross-sectional view of another embodiment of said sill or hob mould depicting two embodiments of said chair;

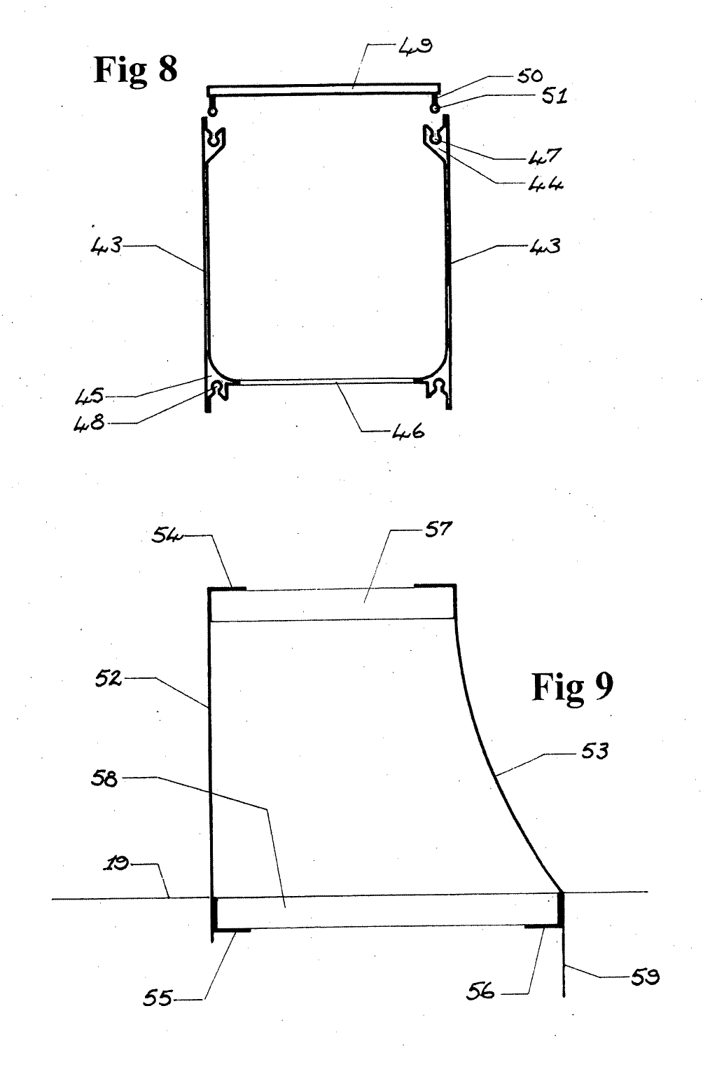

FIG. 8 is a transverse cross-sectional view of an embodiment of said sill or hob mould intended to be extruded in continuous lengths from a suitable thermoplastic polymer or light metal alloy material;

FIG. 9 is a transverse cross-sectional view of an embodiment of said sill or hob mould made with an asymmetric shape;

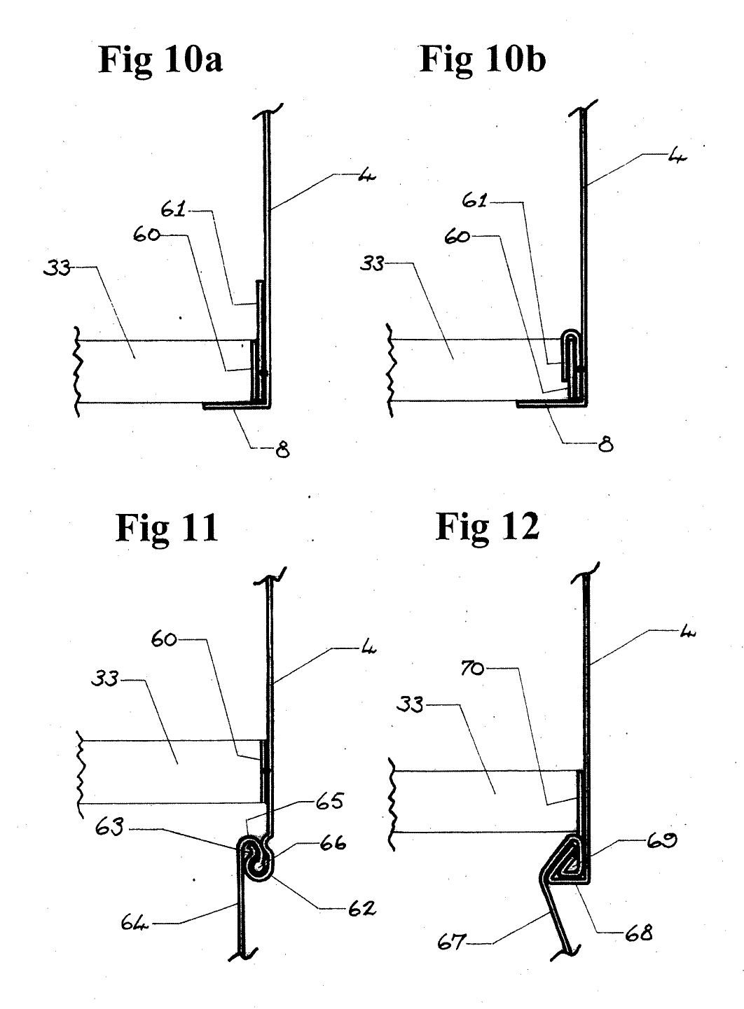

FIG. 10a is a fragmentary transverse cross-sectional view of means to join spacers to the side panels of said sill or hob moulds;

FIG. 10b is a fragmentary transverse cross-sectional view of the joining means of FIG. 10a following their setting;

FIG. 11 is a fragmentary transverse cross-sectional view of means to join said sill or hob moulds to said chairs;

FIG. 12 is a fragmentary transverse cross-sectional view of means to join said sill or hob moulds to said chairs or to join spacers to the side panels of said sill or hob moulds;

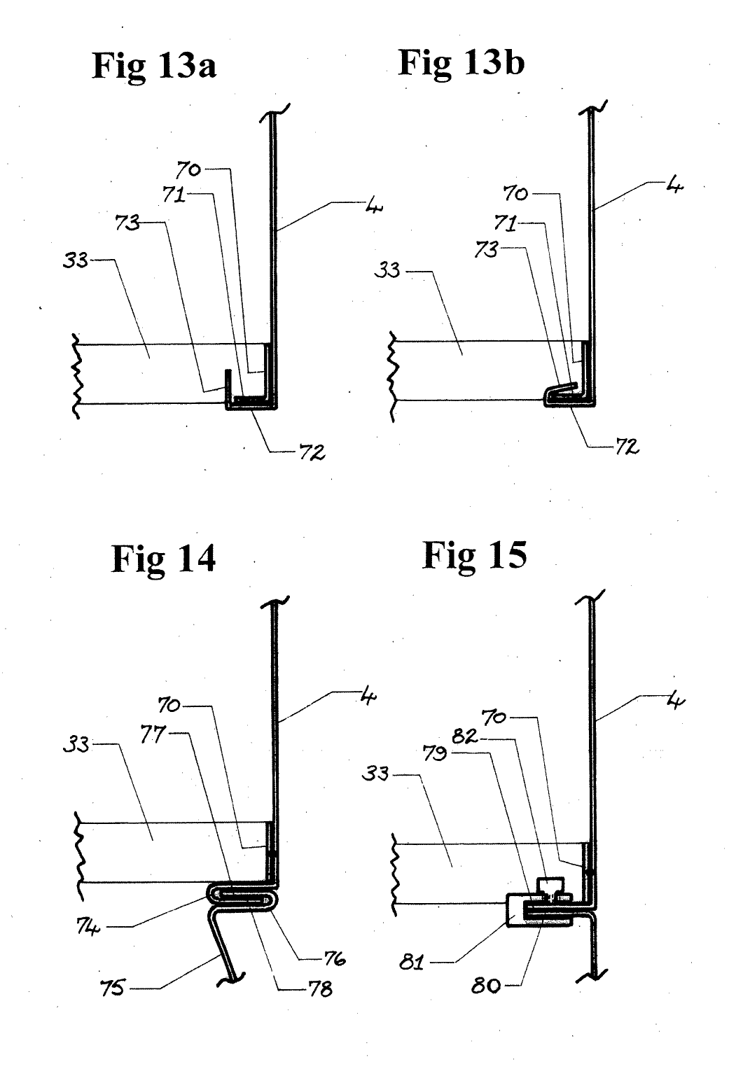

FIG. 13a is fragmentary transverse cross-sectional view of means to join spacers to the side panels of said sill or hob moulds;

FIG. 13b is a fragmentary transverse cross-sectional view of the joining means of FIG. 13a following their setting;

FIG. 14 is a fragmentary transverse cross-sectional view of means to join said sill hob moulds to said chairs;

FIG. 15 is a fragmentary transverse cross-sectional view of alternative means to join said sill or hob moulds to said chairs;

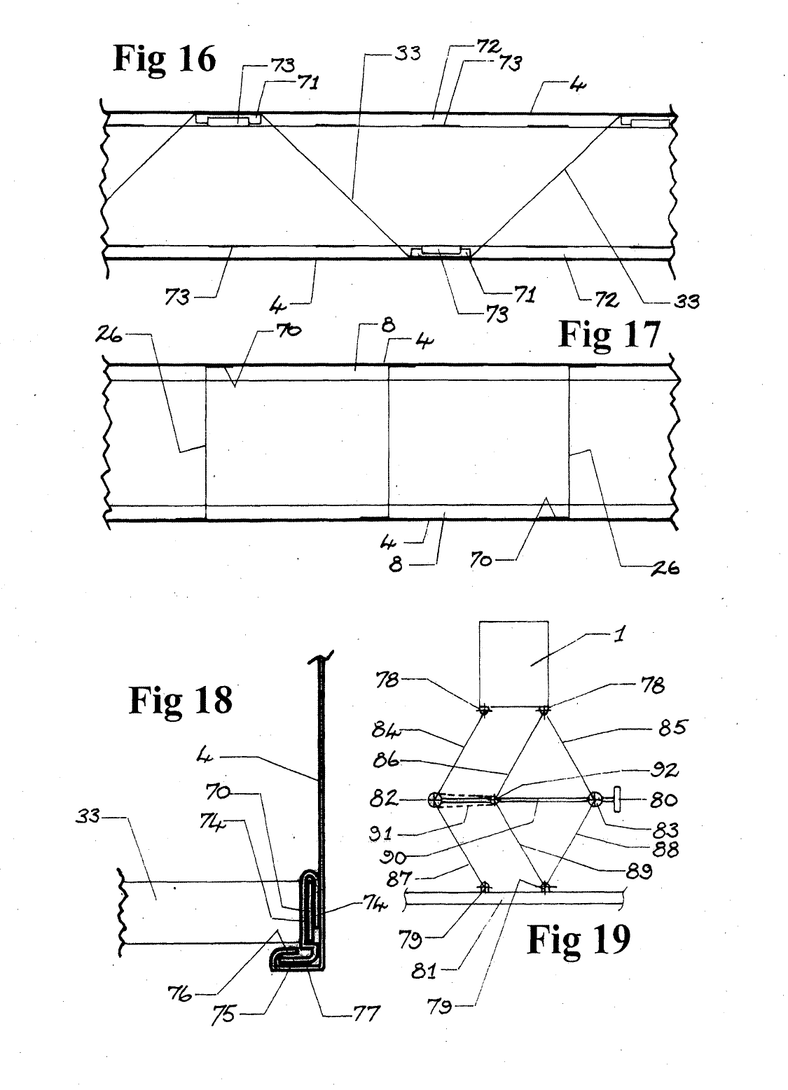

FIG. 16 is a fragmentary view from above of one embodiment of spacers inserted between side panels of said sill or hob moulds;

FIG. 17 is a fragmentary view from above of another embodiment of spacers inserted between side panels of said sill or hob moulds;

FIG. 18 is a fragmentary transverse cross-sectional view of means to join spacers to side panels of said sill or hob moulds;

FIG. 19 is a side view in skeletal form of an embodiment of a chair to support said sill or hob moulds which permits precise height adjustment.

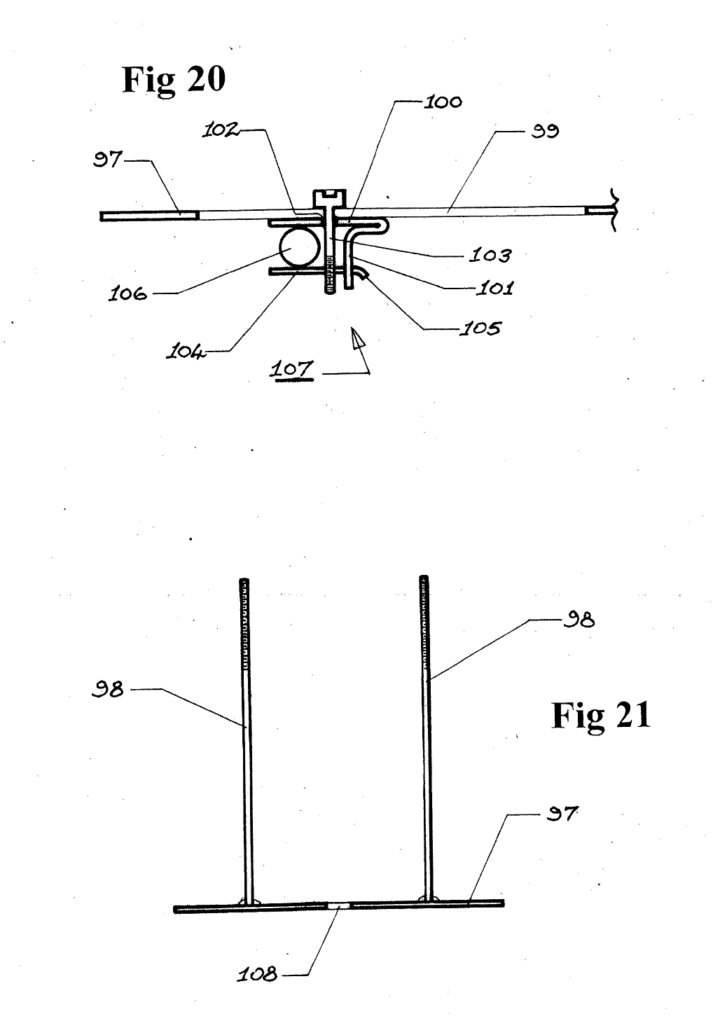

FIG. 20 is a fragmentary, transverse cross-sectional view of clamping means to attach a chair to reinforcing bar;

FIG. 21 is a transverse cross-sectional view of an alternative embodiment of chair comprising threaded rods supported from a base plate;

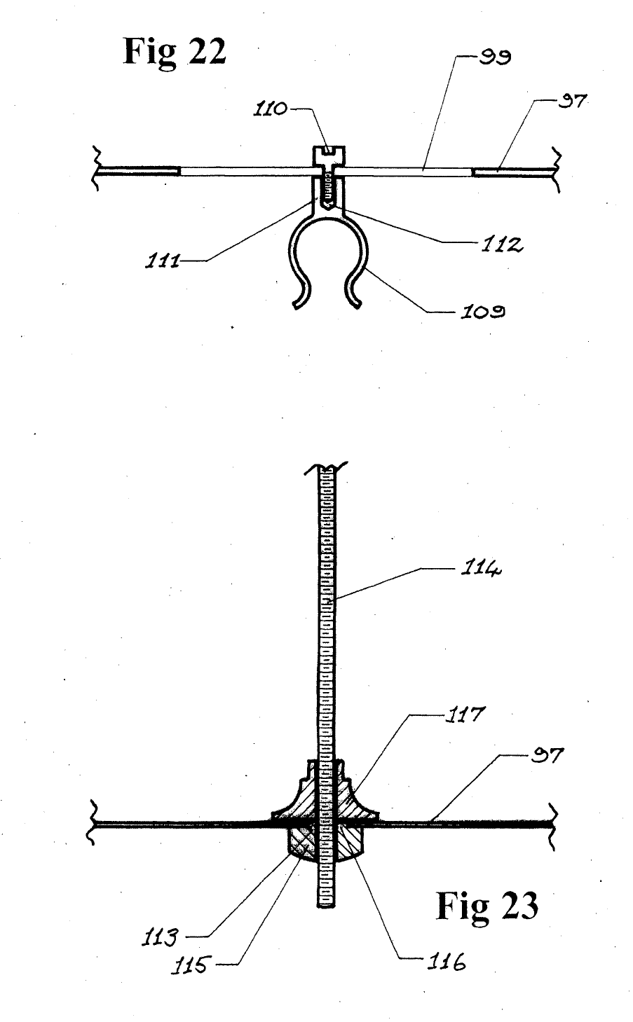

FIG. 22 is a fragmentary, transverse cross-sectional view of an alternative embodiment of clamping means to attach a chair to reinforcing bar;

FIG. 23 is a fragmentary, transverse cross-sectional view of alternative means of attaching a threaded rod of a chair to its supporting base plate;

FIG. 24 is a view from above of an embodiment of the plate of a rod and plate-type chair;

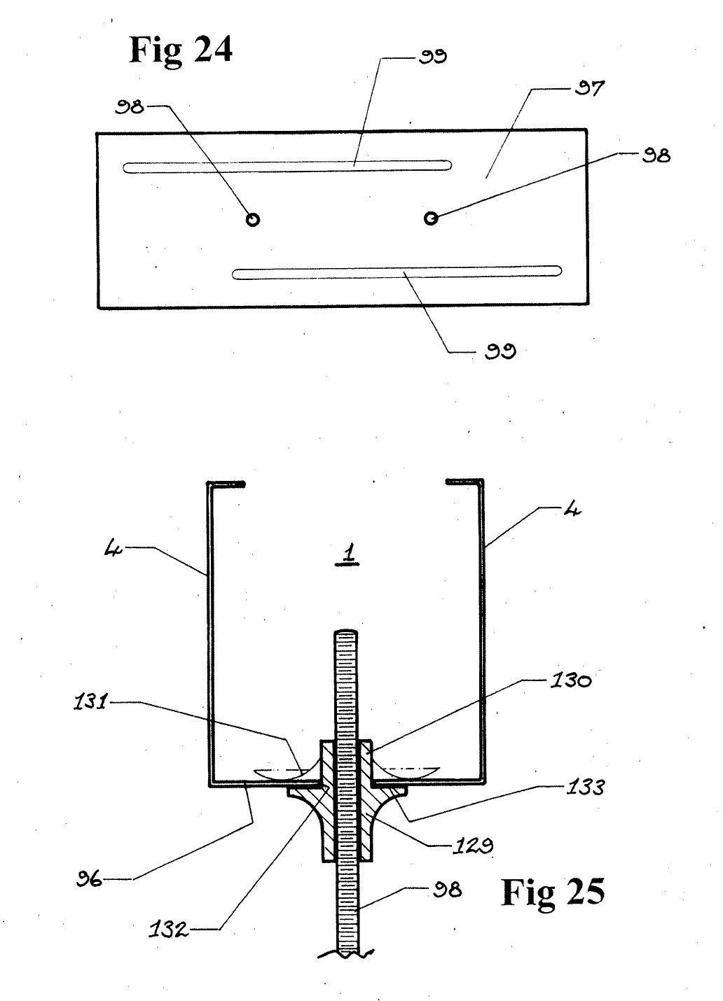

FIG. 25 is a fragmentary transverse cross-sectional view of adjustable means to fix said sill or hob mould to the rods of a rod and plate-type chair;

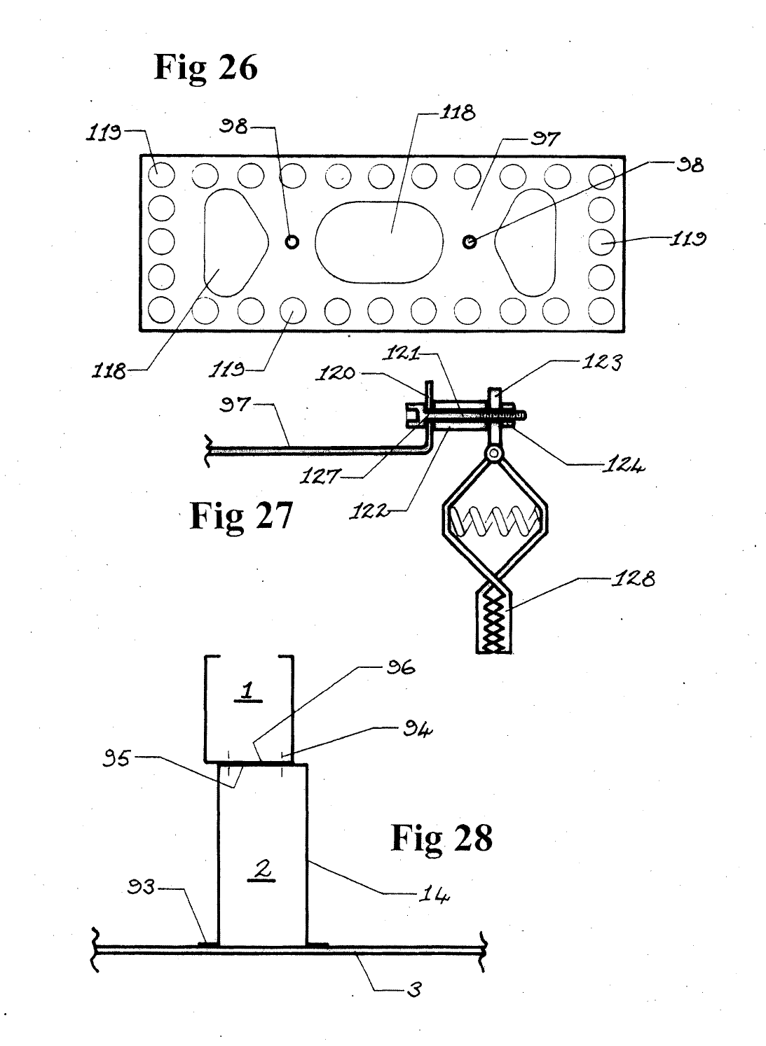

FIG. 26 is a view from above of an alternative embodiment of rod and plate-type chair;

FIG. 27 is a fragmentary, transverse cross-sectional view of an alternative embodiment of clamping means to attach a chair to reinforcing bar;

FIG. 28 is a fragmentary, transverse cross-sectional view of means allowing lateral positional adjustment in fixing said sill or hob mould to a chair;

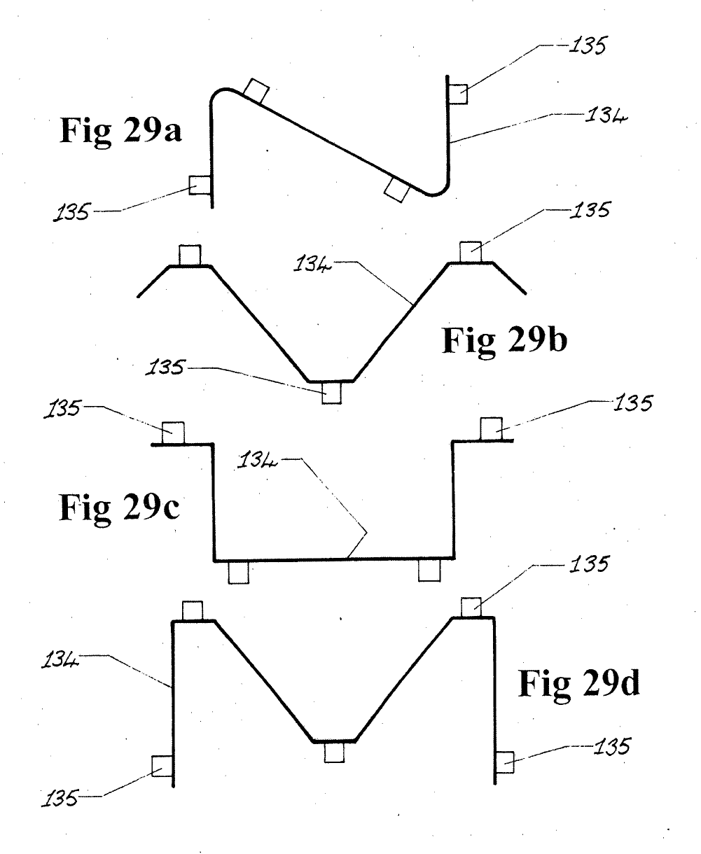

FIGS. 29a, 29b, 29c and 29d are transverse cross-sectional views of alternative forms of chair;

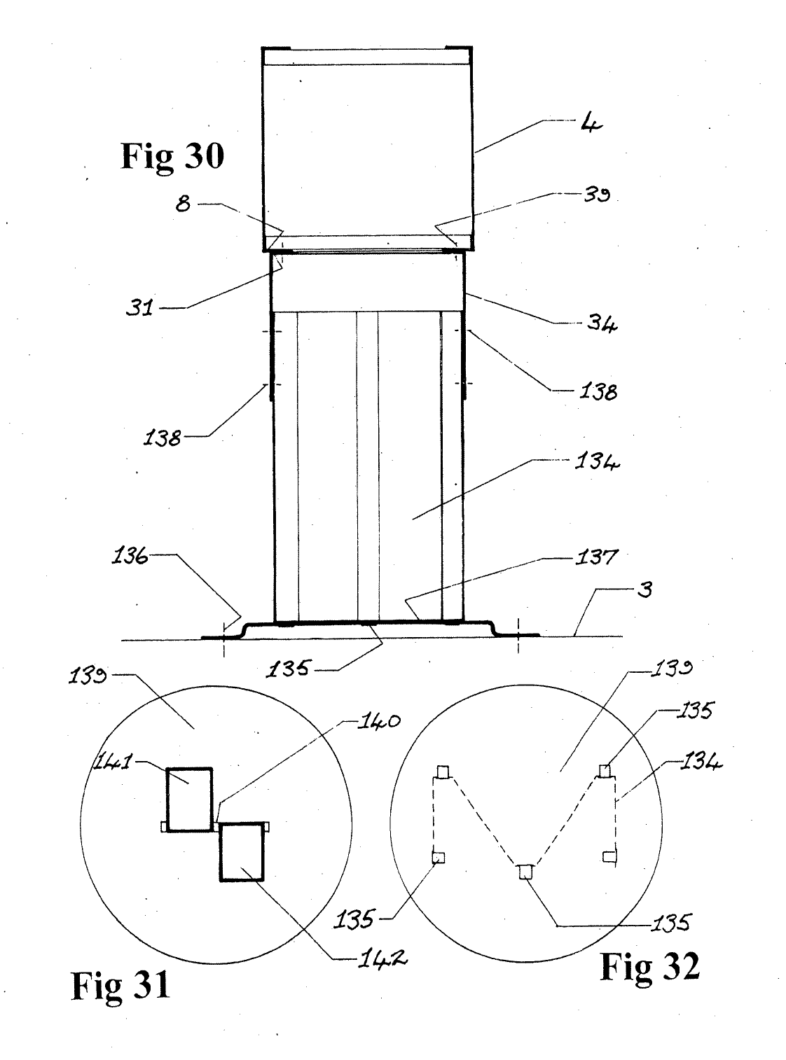

FIG. 30 is a transverse cross-sectional view of a chair incorporating the section of FIG. 29d to support a sill or hob mould at an of adjustable height;

FIG. 31 is a face view of a bifurcated attachment tab arrangement;

FIG. 32 is a face view of the reverse side of a base plate or sill or hob mould at the point of attachment of a chair incorporating the section of FIG. 29d;

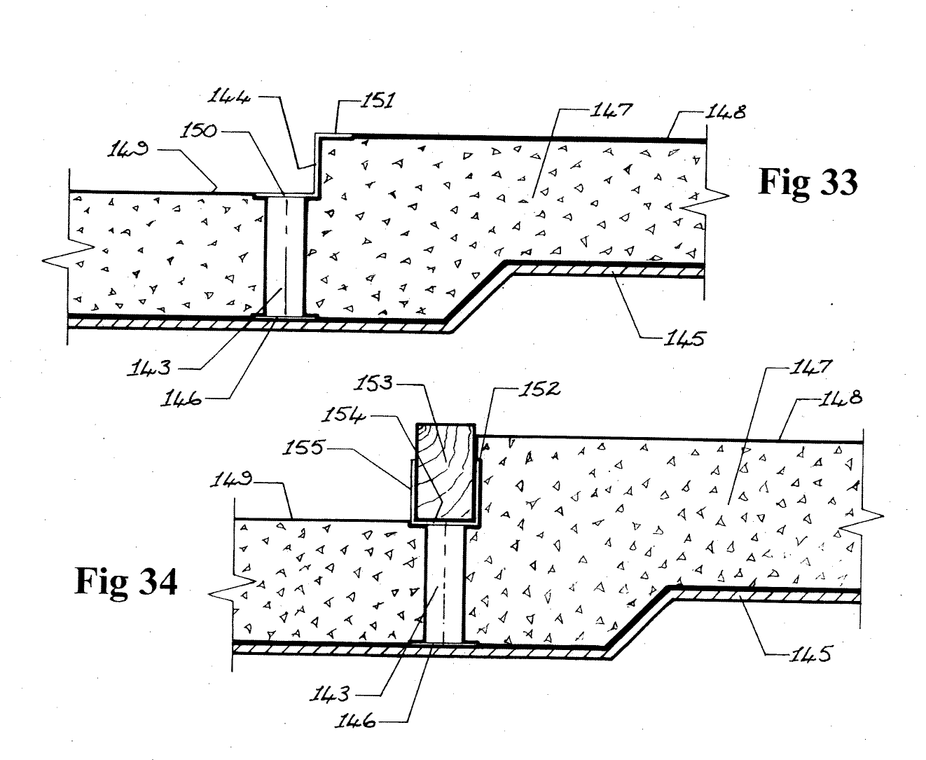

FIG. 33 is a partial longitudinal cross-sectional view of a stepped concrete slab made in accordance with a first embodiment of the present invention;

FIG. 34 is another partial longitudinal cross-sectional view of a stepped concrete slab made in accordance with a second embodiment of the present invention.

The various figures are drawn to different scales and no inference should be drawn from this.

With reference to FIGS. 1, 2 and 3, sill or hob mould 1 is supported upon chair 2 which is, in turn, fixed to formwork 3. Said sill or hob mould comprises side panels 4 joined in spatial relationship at their upper edges by a plurality of spacer clips 5. Said side panels are joined in fixed spatial relationship at their lower edges by spacer piece 6 being tack-welded to upstanding flanges 7 formed on lower transverse flanges 8. Conveniently, said spacer piece takes the form of a short section cut from a continuous length of rectangular tube section. With additional reference to FIGS. 2 and 3, the upper edges of said side panels are turned through 90° to create upper transverse flanges 9 which are engaged by tabs 10 of said spacer clips to retain said clips in position. Said upper edges of said side panels are maintained in spatial relationship by their abutment with the inner surfaces of downturned edge flanges 11 of said spacer clips and the said engagement of said upper transverse flanges by tabs 10. Upstanding flanges 7 formed on lower transverse flanges 8 and upper transverse flanges 9 act to stiffen, respectively, the lower and upper edges of said sill or hob mould side panels.

Chair 2 is fixed to formwork 3 by nails 12 or other suitable fastenings being driven through suitable apertures in transverse bottom part 13 of said chair. Chair side panels 14 pass upwardly with a lateral separation such as to provide sliding contact of their inner surfaces with the outer surfaces of said sill or hob mould side panels. Transverse bridge 15 fixed to said chair side panels with suitable fastenings 16 supports said sill or hob mould at the desired height above said formwork. Said side panels of said sill or hob mould are secured to said chair side panels by suitable fastenings passing through both. Said sill or hob mould, said chair and the area above said formwork to the desired level are then filled with concrete 18, thereby embedding said chair, and slab surface 19 and the upper surface of the concrete filling of said sill or hob mould are trowelled off to create the desired surface finishes. The fixing of bridge 15 and said sill or hob mould to said chair and the fixing of said chair to said formwork is normally carried out by the appropriate trades during the fixing of reinforcement bar, plates or mesh within said formwork. The height of said bridge is normally set to position the lower edge of said sill or hob mould at the surface of said concrete slab when poured. In alternative embodiments (not shown), the lower edge of said sill or hob mould is set above or below said slab surface when poured. In the preferred embodiment, where a large number of said chairs are required to have said bridges and said sill or hob moulds fixed to them, suitable jigs are provided to position said components appropriately, one to another, and to install said fastenings. Said fastenings optionally take the form of pop rivets, conventional screws or bolts screwed into tapped holes, conventional self-tapping screws, self-piercing and self-drilling/self-tapping screws, self-piercing rivets, hot-melt adhesives, quick-setting two-part adhesives, spot welding or any other suitable fixing means. When the concrete of said slab has cured, said formwork is stripped away and fastenings 12 are hammered flat or preferably cut off or ground away with an angle grinder or the like. In an alternative embodiment (not shown), sill or hob mould side panels 4 are attached to the outer edges of lower transverse flanges 8 by simple hinges, the arrangement permitting said sill or hob moulds to be opened out and shipped flat. When required for use, said side panels are pivoted upwardly through approximately 90° and a plurality of spacer clips 5 is slidingly engaged with upper transverse flanges 9 of said side panels, thereby retaining said sill or hob moulds in a fixed rectangular form.

With reference to FIGS. 4 and 5, a said chair in fixed into place on said formwork by the sprigs 22 of a fixing plate 21 being driven through suitable apertures 20 provided in transverse bottom part 13 of said chair. Said fixing plate is die-punched from a suitable metal sheet material and radially arranged projections 22 are turned through 90° to create attachment sprigs. The use of said fixing plate facilitates the accurate fixed location of said chair, said fixing plate being installed by a single blow from a suitable punch with a round, flared head, a suitable aperture being provided in bridge 15 (as depicted in FIG. 1) to provide access for said punch. In alternative embodiments (not shown), said chairs are fixed to said formwork using any suitable nails, screws or adhesives.

With reference to FIG. 6, two runs 23, 24 of said sill or hob mould are joined by joining member 25. Said joining member is fabricated from suitable sheet material, having the same width and depth as said sill or hob mould. In the preferred embodiment, said sill or hob mould side panels are provided at their upper and lower edges with transverse flanges (typically depicted as 9 and 8 in FIG. 7). Also in the preferred embodiment, the inner edges of said transverse flanges are turned through a further 90° to form inwardly directed flanges parallel to said side panels (depicted as 7 in FIG. 1). The ends of transverse spacers 26 are turned through 90° and spot welded to said upstanding flanges and maintain said side panels in fixed spatial relationship. Oblique strap 29 is spot welded to upper and lower transverse flanges 8 to strengthen the corner of said joining member. Transverse straps 27 are spot welded to said upper and lower transverse flanges to maintain a precise geometry of said sill or hob mould at the joining point, said sill or hob mould runs abutting said joining member at points 28. Doublings (not shown) are fixed to the inner surfaces of said joining member and extend outwardly to enter and abut the inner surfaces of the ends of said sill or hob mould side panels with a suitable degree of overlap. The fixing of said doublings to said side panels of said sill or hob moulds using suitable fastenings is the method of joining said sill or hob mould runs to said joining member. Said joining member is supported from said formwork by a chair having a square or equi-armed, L-shaped base, one corner or the apex 30 of which, respectively, is exposed. In the preferred embodiment, said corner or apex is fixed to said formwork (depicted as 3 in FIG. 1) using a fixing plate (depicted as 21 in FIG. 5). In alternative embodiments, any conventional fixing means are employed. Upwardly extending chair side panels 14 are fixed to or formed on the edges of said chair in appropriate positions such that their internal surfaces make sliding contact with the external surfaces of said sill or hob mould side panels. Bridges (depicted as 15 in FIG. 1) are fixed to said chair side panels to support said joining member at an appropriate height above said formwork. Said chair side panels are fixed to said sill or hob mould side panels in the manner described in relation to FIG. 1. Said joining members are optionally fabricated in different forms to join lengths of said sill or hob mould at a range of angles. Said joining members and said sill or hob mould are optionally made from a variety of materials, including light metal alloys, steel alloys and engineering polymers, where necessary, appropriately treated against corrosion.

With reference to FIG. 7, in an alternative embodiment, said sill or hob mould is made with symmetrical side panels, the upper and lower edges of which are turned through 90° to create upper and lower transverse flanges 8, 9. The ends of transverse spacers 32, 33 are turned through 90° and spot welded to said side panels. In an alternative embodiment (not shown), said spacers are made in continuous, zig-zag-type form with small flats parallel to said sill or hob mould side panels provided between each angled part, said flats being spot welded to said side panels. Said embodiment is suited for continuous production in which said side panels are formed up from continuous lengths of flat, rolled metal strip and straightened, said side panels are brought together with said continuous, zig-zag-type spacers between them and said spacers are spot welded to said side panels. Depending upon the dimensions of said sill or hob mould, the vertical width of said transverse spacers and said zig-zag-type spacers falls in the range 10 millimetres to substantially the same height as said sill or hob mould. In an alternative embodiment (not shown), said sill or hob mould is formed up from continuous lengths of rolled metal strip in a generally U-shaped form and panels of suitable size are punched or otherwise cut out from the lower transverse panel to create voids separated by narrow transverse strips. In this embodiment, for stiffening purposes, the upper edges of said side panels of said sill or hob mould are at least turned through 90° to form transverse flanges (depicted as 9 in FIG. 2). In the preferred embodiment, robotic spot welding means are employed to fix said spacers to said sill or hob mould side panels. Said chair is made with two overlapping or telescopic side panels 14, 34, the abutting surfaces of which are in sliding contact. Said side panels are made with coincident slotting and a bolt 35 passes through said slotting such that, when nut 37 is tightened onto the threaded end of said bolt, said side panels are captured between the ends of crush tube 36, the head of said bolt and said nut. The upper ends of chair side panels 34 are turned through 90° to create transverse fixing flanges 31. Said sill or hob mould is fixed to said chair by suitable fastenings 39 passing through lower transverse flanges 8 and transverse fixing flanges 31. The height of said sill or hob mould above formwork 3 is set by loosening nut 37, slidingly adjusting the height of said chair and re-tightening said nut. In an alternative embodiment (not shown), separate guide slots are provided in one pair of said chair side panels (14, 14 or 34, 34) which are engaged by suitable guide buttons provided on the other pair of said chair side panels, said embodiment acting to maintain said side panels in alignment during their said sliding adjustment. In another alternative embodiment (not shown), only one pair (14, 14 or 34, 34) of said chair side panels is slotted and said bolt is retained in suitable apertures in said other pair of side panels. Chair side panels 14 are fixed to formwork 3 by suitable fastenings (typical positions indicated in broken line as 38) driven through suitable apertures in transverse bottom part 13. In an alternative embodiment, a transverse partition (position depicted in broken line as 40) is provided joining the upper ends of chair side panels 34 and a transverse partition (position indicated in broken line as 41) is provided joining the lower ends of chair side panels 14. Height adjustment screws (positions indicated in broken line as 42) pass between said partitions, in the preferred embodiment, said screws being of the inter-screw type in which a male screw of conventional form with an extended threaded part engages a female (tubular) screw with an extended threaded part. Shortening of said screws (by deepening the engagement of the male screw with the female) acts to increase the height of said sill or hob mould above said formwork. In an alternative embodiment, said screws are long screws of conventional form and their heads are rotationally captured at one said partition, the other ends of said screws engaging nuts fixed to the other said partition. Rotation of said screws in the appropriate sense increases or decreases the height of said sill or hob mould above said formwork. The height of said sill or hob mould is normally set to position its lower edge at the finished surface of said slab when poured. In alternative embodiments (not shown), the lower edge of said sill or hob mould is set above or below said slab surface when poured. With additional reference to FIG. 28, in an alternative embodiment, chair 2 is made with a transverse top part 95 joining the upper edges of side panels 14 and said chair is fixed to formwork 3 by fastenings passing through suitable tabs or flanges 93 formed on the lower edges of said side panels. Said transverse top part is made with transversely arranged slots (not shown) which permit the lateral position of sill or hob mould 1 to be adjusted before said sill or hob mould is fixed to said chair with suitable fastenings (typical positions indicated as 94). In the preferred embodiment, said fastenings take the form of bolts passing through any of a plurality of suitable apertures (not shown) in narrow, transversely arranged strips 96 joining the lower edges of said sill or hob mould side panels, through said slots and screwably tightened into nuts (not shown) positioned beneath said chair transverse top part.

With reference to FIG. 8, said sill or hob mould is extruded in a continuous length from a thermoplastic polymer material or light metal alloy material. Said extruded section comprises two side panels 43 connected at the lower end by a transverse web which is punched or otherwise cut out to create voids 46 separated by narrow transverse strips. Longitudinal rails 44, 45 are provided along the upper and lower inner, edges of said side panels and channels 47, 48 are provided in said rails. Said channels are made with an approximately circular cross-sectional shape to which access is gained via slots. Said slots are orientated, respectively in relation to channels 47, 48, upwardly and downwardly. Said slots taper inwardly to a width being approximately 10% to 20% smaller than the diameter of said channels and, as such, form constricted entries to said channels. Said chair side panels (not shown) are made with their upper edges substantially cylindrical in form and with a diameter able to be neatly accommodated within channels 48. Said sill or hob mould is fixed to said chair by said chair side panel upper edges being forced through said slots to frictionally engage channels 48. Closure 49 is made with shallow longitudinal rails 50 along each edge, the free edges of said rails being made in substantially cylindrical form with a diameter able to be neatly accommodated within channels 47. Said closure is fixed to said sill or hob mould by said rail edges being forced through said slots to frictionally engage channels 47. In an alternative embodiment (not shown), suitable apertures are punched or otherwise cut out from said closure to create voids separated by narrow transverse strips. In another alternative embodiment (not shown), said sill or hob mould is extruded in a single section, with side panels 43 connected at their upper and lower ends by transverse webs which are both punched or otherwise cut out to create voids separated by narrow transverse strips. In another alternative embodiment (not shown) said chair side panels are made from metal sheet and their upper edges are made into a substantially cylindrical form by rolling or by fixing a wire along said edges, the diameter of said rolling or said wire being such as to be neatly accommodated within channels 48.

With reference to FIG. 9, said sill or hob mould is made in asymmetric cross-sectional form, with a first flat face 52 and a second face 53 shaped to suit a particular application. In the embodiment shown, said second face is made concave with said mould increasing in width downwardly to suit the mounting of a hospital wall in which vinyl floor tiles are curved to pass from the floor surface to the wall surface. The arrangement is intended to improved hygiene by eliminating the difficult-to-clean zone normally existing at the junction of a wall with a floor surface. The upper edges of said side panels are turned through 90° to create upper transverse flanges 54 and transverse or zig-zag-type spacers 57 of the type described in relation to FIG. 7 are spot welded to said side panels. Longitudinally arranged angles 55, 56 are spot welded to the lower inner edges of said side panels and transverse or zig-zag-type spacers 58 of the type described in relation to FIG. 7 are spot welded to said angles. Curved side panel 53 is extended vertically downwards to create apron 59 such that, when said sill or hob mould is embedded in the surface of a concrete building slab (typical surface level of said slab indicated as 19), said apron forms a positive moisture barrier.

With reference to FIG. 10a, the lower edge of said sill or hob mould side panel 4 is turned through 90° to create lower transverse flange 8. Tab 61 is spot welded at its lower end to said side panel. Flat 60 of a zig-zag-type spacer 33 of the type described in relation to FIG. 7 abuts said side panel. With additional reference to FIG. 10b, said tab has been bent downwardly and against said flat, thereby fixing said spacer to said side panel.

With reference to FIG. 11, the lower edges of said sill or hob mould side panel side panel 4 of have been turned through approximately 180° to create channels 62 with lipped, constricting edges 63. The upper edges of chair side panels 64 are made with substantially cylindrical edges 66 which are turned through approximately 180° at bends 65. In the preferred embodiment, said chair side panels are made from metal sheet and their upper edges are made into substantially cylindrical form by rolling or by fixing of a wire along said edges, the diameter of said rolling or said wire being such as to be neatly accommodated within channels 62. Said sill or hob mould is fixed to said chair side panel edges by edges 66 being forced past constricting edges 63 to be frictionally captured within channels 62. The turned ends 60 of transverse spacer 33 (or flats of zig-zag-type spacers of the type described in relation to FIG. 7) are spot welded to said sill or hob mould side panels. In an alternative embodiment (not shown), part of said lower edges of said sill or hob mould side panels of suitable width are turned upwardly and tightly through 180° and approximately half of the upturned part is then turned downwardly through 180° to create downwardly orientated channels with constricting edges of the type depicted in FIG. 11. The upper edges of said chair side panels are made rolled or wired as described in relation to FIG. 11, said edges being of a diameter as may be neatly accommodated within said channels. Said sill or hob mould is fixed to said chair by said rolled or wired edges being forced past said constricting edges to be frictionally captured within said channels.

With reference to FIG. 12, short, downwardly projecting parts of the lower edges of said sill or hob mould side panels 4 are double folded to create a plurality of more or less triangular sections 68. Short upwardly projecting parts of the upper edges of said chair side panels are double folded to create a plurality of more or less triangular sections 69 able to be neatly accommodated within sections 68. Said sill or hob mould is fixed to said chair side panels by sections 69 being interdigitated between sections 68, the former then being displaced laterally to enter and be frictionally captured within the latter. In an alternative embodiment (not shown), the turned ends 70 of transverse spacer 33 (or flats of zig-zag-type spacers of the type described in relation to FIG. 7) are made with downwardly extending parts which are double folded into more or less triangular sections able to be frictionally captured within sections 68 in the manner described.

With reference to FIG. 13a, the lower edges of said sill or hob mould side panels 4 are double folded to form lower transverse flanges 72 with short lengths of upstanding flange 73 formed on them. The turned ends 70 of transverse spacers 33 (or flats of zig-zag-type spacers of the type described in relation to FIG. 7) are made with short lateral extensions 71 formed on their lower edges. With additional reference to FIG. 13b, lengths of upstanding flange 73 have been folded down to capture short lateral extensions 71, thereby fixing said transverse spacers to said side panels.

With reference to FIG. 14, the lower edges of sill or hob mould side panels 4 are turned inwardly through 90° and approximately half of said turned part turned outwardly through 180° to create outwardly orientated attachment channel 74. The upper edges of said chair side panels are treated in a reciprocal way to create inwardly orientated attachment channel 76. Said sill or hob mould is fixed to said chair by the free end 77 of said chair side panel upper edge being accommodated within attachment channel 74 and the free end of sill or hob mould side panel lower edge 78 being accommodated within attachment channel 76. The turned ends 70 of transverse spacers 33 (or flats of zig-zag-type spacers of the type described in relation to FIG. 7) are spot welded to said sill or hob mould side panel.

With reference to FIG. 15, The lower edges of said sill or hob mould side panels are turned through 90° to create lower transverse flange 79. The upper edges of said chair side panels are turned through 90° to create attachment flanges 80. Said sill or hob mould is fixed to said chair by the abutting said lower transverse flange and attachment flange being clamped together by screw means 82 of a plurality of suitably spaced clamps 81. The turned ends 70 of transverse spacers 33 (or flats of zig-zag-type spacers of the type described in relation to FIG. 7) are spot welded to said sill or hob mould side panel.

With reference to FIG. 16, the side panels 4 of said sill or hob mould are joined at their upper and lower edges by a continuous length of zig-zag-type spacers of the type described in relation to FIG. 7, said spacers being attached to said side panels as described in relation to FIGS. 13a and 13b. In this embodiment, flats of said spacers are provided with short lateral extensions 71 formed on their lower edges, short upstanding flanges 73 formed on the inner edges of lower transverse flanges 72 being folded down to capture said short lateral extensions. Said embodiment is suited for continuous production in which said side panels are formed from rolled metal strip and straightened, said side panels are brought together with said continuous, zig-zag spacers between them and said spacers are fixed in the manner described to said side panels. In an alternative embodiment (not shown), said spacers are made in the form of a continuous sinusoidal curve and are clipped into place in the manner described in relation to this Figure or are spot welded into place at the points of contact with said side panels.

With reference to FIG. 17, side panels 4 of said sill or hob mould are joined by a plurality of transverse spacers 26, the turned ends 70 of which are spot welded to the upper and lower edges of said side panels. Said embodiment is suited for continuous production in which said side panels are formed up from flat, rolled metal strip and straightened, said side panels are brought together with said transverse spacers between them and said spacers are spot welded to said side panels.

With reference to FIG. 18, the lower and upper edges of sill or hob mould side panels 4 are turned through two 90° folds to form lower and upper transverse flanges 77, each having short upstanding or downwardly directed (as appropriate) flanges 76 formed on them. Clips 74 are folded over the turned ends 70 of transverse spacers 33 (or flats of zig-zag-type spacers of the type described in relation to FIG. 7) and lateral extensions 75 of said clips are positioned to abut said lower or upper (as appropriate) transverse flanges. Upstanding or downwardly directed (as appropriate) flanges 76 are then folded inwardly to capture said turned ends of transverse spacers 33 (or flats of zig-zag-type spacers of the type described in relation to FIG. 7), thereby joining said sill or hob mould side panels one to another.

With reference to FIG. 19, sill or hob mould 1 is supported at either side upon parallelogram mechanisms formed from upper straps 84, 85, 86 the upper ends of which are pivotally joined to the lower edges of said sill or hob mould at pivots 78 positioned on each side of said sill or hob mould and pivotally joined to lower straps 87, 88, 89 at the ends of transverse nut bar 82, at laterally located pivots 92 and at transverse bearing bar 83. Said lower straps are pivotally joined to formwork 81 at pivots 79. Links 91 on either side maintain said nut bar and pivots 92 in fixed spatial relationship. Threaded rod 90 is rotationally captured in a medially positioned bearing (not shown) in said bearing bar and knob 80 is provided to turn it. Said threaded rod passes between laterally located pivots 92 and its distal end is screwably engaged with a medially positioned nut (not shown) in said transverse nut bar, rotation of said threaded rod in the appropriate direction acting to draw said bearing bar and said nut bar closer together or to increase their separation, thereby increasing the height of said sill or hob mould above said formwork of reducing said height. In the preferred embodiment, said straps are made from a stiff metal section and said pivots are made tight with no free play, thereby minimising any tendency for said sill or hob mould to sway or otherwise deviate from its desired position. The advantage of the said embodiment is its ability to provide precise height adjustment of said sill or hob mould. In the preferred embodiment, pivots 79 are fixed in common to a plate which is, in turn, fixed to said formwork.

With reference to FIG. 24, in an alternative embodiment, a chair to support said sill or hob mould comprises base plate 97 to which are fixed two, parallel, threaded supporting rods 98 of suitable length orientated normal to said base plate. Parallel slots 99 are provided in said base plate.

With additional reference to FIG. 20, in an alternative embodiment, base plate 97 is made with one or more slots 99. Clamp 107 comprises flat base part 100 on one end of which is formed supporting piece 101. Fixing screw 103 passes through a said slot and through medially positioned aperture 102 in said flat base part and its threaded part is screwably engaged with the complementary thread of a suitable aperture (not shown) provided in jaw 104. One end of said jaw is formed into tongue 105 which passes through a suitable aperture positioned towards the free end of said supporting piece. With said fixing screw loosened, said clamp may be slideably positioned along slot 99 of plate 97 and a reinforcing bar 106 may be positioned between adjacent faces of said flat base part and said jaw. Tightening of said fixing screw simultaneously locks said clamp to said plate and seizes said reinforcing bar between said flat base part and said jaw.

With reference to FIG. 21, in an alternative embodiment, a chair to support said sill or hob mould comprises base plate 97 to which are fixed two, parallel, threaded supporting rods 98 of suitable length orientated normal to said base plate. One or more slotted apertures 108 are provided in said base plate and suitable fastenings passing through said apertures are employed to fix said base plate to supporting bars (not shown) which are, in turn, fixed to reinforcing bars (not shown) by a variety of fixing means (not shown). Said slotted apertures permit positional adjustments of said base plate to be made before said base plate if fixed to said supporting bars. In other alternative embodiments (not shown), said chairs comprising base plate and parallel, threaded supporting rods are fixed to said formwork by means of suitable fastenings passing through slotted openings in said baseplate. In these embodiments, said slotted openings permit positional adjustment of said chair prior to tightening of said fastenings.

With reference to FIG. 22, in an alternative embodiment, the base plate 97 of a said chair is provided with one or more slots 99 from which clips 109 are supported by the screwable engagement of the threads of their fixing screws 110 with complementary threads of a bore 112 provided in attachment boss 111. Said fixing screws pass through said slots and, with said fixing screws loosened, said clips may be positioned to permit them to engage and be frictionally attached to reinforcing bars (not shown). Tightening of said fixing screws acts to fix said clips to said base plate and, thereby, to fix said base plate to said reinforcing bar.

With reference to FIG. 23, in an alternative embodiment, base plate 97 of a said chair is made with one or more slots 113. Threaded rods 114 of said chair are fixed to said base plate by upper nuts 117 being screwably displaced on the threading of said rods against lower nuts 115. Suitable shoulders 116 of said lower nuts engage said slots, thereby preventing said lower nuts from turning during tightening of said upper nuts. Obviously, the height of a said threaded rod on said base plate may be adjusted by screwably displacing said upper and lower nuts on said threaded rods.

With reference to FIG. 26, in an alternative embodiment, a chair to support said sill or hob mould comprises base plate 97 to which are fixed two, parallel, threaded supporting rods 98 of suitable length orientated normal to said base plate. Suitable apertures 118 are provided in said base plate to facilitate a flow of concrete through said base plate. Suitable fixing apertures 119 are provided around the periphery of said base plate and said base plate is secured to reinforcing bar (not shown) by wire ties passed through said fixing apertures, around said reinforcing bar and the ends twisted together and tightened.

With reference to FIG. 27, in an alternative embodiment, the base plate 97 of a said chair is provided with upstanding edge flanges 120 provided with longitudinally orientated slots 127. Clips 128 are supported from said edge flanges by their fixing screws 121 passing through said slots, through spacer tubes 122 and through attachment webs 123 of said clips such that their threaded parts screwably engage and are tightened into complementary threads in nuts 124. In the preferred embodiment, said clips are of the larger alligator type. With said fixing screws loosened, said clips may be positioned on said edge flanges to permit them to engage and be attached to reinforcing bars (not shown). Tightening of said fixing screws acts to fix said clips to said base plate edge flanges and, thereby, to fix said base plate to said reinforcing bar. Where the height of said base plate is required to be adjusted in relation of said reinforcing bar, said fixing screws are loosened, said clips are partially released from said reinforcing bar and said clips are rotated on said fixing screw as required to perform said height adjustment. Said clips are then permitted to engage said reinforcing bar and said fixing screws are re-tightened.

With reference to FIG. 25, in an alternative embodiment, gill or hob mould 1 is supported on threaded supporting rods 98 fixed to a base plate (not shown). Threads of nuts 129 are screwably engaged with complementary threads of said supporting rods and tubular projections 130 formed on the upper ends of said nuts pass upwardly through suitable apertures 132 provided in narrow, transversely arranged strips 96 joining the lower edges of said sill or hob mould side panels 4. Dished, metal spring washers 131 are pressed over said tubular projections with small sprigs (not shown) formed around their central apertures engaging the external surfaces of said tubular projections, thereby retaining said spring washers in place and which, by urging said transversely arranged strips against shoulders 133 of said nuts, act to retain said sill or hob moulds in the correct vertical attitude on said supporting rods. In the preferred embodiment, said threading of said supporting rods is made coarse and said nuts are formed from a suitable thermoplastic polymer material providing a firm frictional engagement with said threading. Also in the preferred embodiment, the upper ends of said tubular projections are made hexagonal or other shape intended for engagement by a suitable tool employed to turn said nuts on said supporting rods. Also in the preferred embodiment, said tool is a tube spanner.

In alternative embodiments (not shown), the rods of said base plate and rod-type chair are made plain and unthreaded and said sill or hob mould is secured in place on said rods by suitable clips frictionally attached to said rods above and below the appropriate surfaces of said sill or hob mould.

With reference to FIGS. 29a, 29b, 29c and 29d, said sill or hob mould is supported upon a chair formed from a suitable length of folded metal section 134. The cross-sectional shape of said folded metal section is selected to provide torsional, transverse and longitudinal stiffness. In the preferred embodiment, said folded metal section is cut to length by shearing between two dies shaped to match its said cross-sectional shape. According to the attachment requirements of said folded metal section, it is optionally cut straight across or, where appropriate, said dies are shaped to provide a plurality of attachment tabs 135 formed on one or both ends. Said attachment tabs are employed, as appropriate, to fix the lower end of said chair to a base plate or its upper end to said sill or hob mould. In the preferred embodiment, suitably positioned slots are punched in said base plate or said sill or hob mould base using a portable hydraulically-operated punch. As depicted in FIGS. 30 to 32, said attachment tabs are passed up through said slots and are bent over flat to secure said folded metal section into place. In an alternative embodiment (not shown), said attachment tabs are twisted through approximately 90° to effect the attachment of said folded metal section. In another alternative embodiment (not shown), said attachment tabs are passed through suitable apertures and secured by welding. The embodiment of said folded metal section depicted at FIG. 29b is preferred as it provides the necessary positional stability with the use of only three said attachment tabs.

With reference to FIG. 30, a chair comprises folded metal section 134 and side panels 31. The lower end of said folded metal section is fixed to base plate 137 by a plurality of attachment tabs 135 passed through suitable slots and folded flat. Said base plate is suitably joggled to accommodate said attachment tabs and is fixed to formwork 3 by means of suitable fasteners (positions indicated as 136). The upper ends of said chair side panels are turned through 90° to create transverse fixing flanges 31. Sill or hob mould 4 is fixed to said chair by suitable fastenings (positions indicated as 39) passing through lower transverse flanges 8 of said sill or hob mould and transverse fixing flanges 31. Vertical slots (not shown) are provided alternatively in side panels 34 or the sides of said folded metal section with suitable apertures in the other. Suitable fastenings (positions indicated as 138) passing through said side panels and said sides of said folded metal sections permit sliding height adjustment of said sill or hob mould when loosened. Obviously, in an alternative embodiment (not shown), said folded metal section may be cut to the requisite length and its upper end fixed directly to said sill or hob mould. Where this embodiment is employed, transverse strips of material are provided across the lower surface of said sill or hob mould to permit said fixing of said folded metal section. In another alternative embodiment (not shown), a similar sectional shape moulded from a suitable polymer material replaces said folded metal section and its ends are fixed to said sill or hob mould or said base plate by its said attachment tabs being passed through suitable slots and fused with a suitable hot implement. Obviously, said folded metal section may take a large variety of other cross-sectional shapes.

With reference to FIG. 32, attachment tabs 135 on an end of folded metal section (position indicated in broken line as 134) are folded over flat to fix said folded metal section to sill or hob mould or baseplate 139.

With reference to FIG. 31, in an alternative embodiment, said attachment tabs are made in closely-spaced pairs 141, 142 and said folded metal section is fixed to sill or hob mould or baseplate 139 by passing said attachment tabs through a common slot 140 and then bending them flat in opposed senses.

With reference to FIG. 33, in a first embodiment in which a step or break in level of a poured concrete slab 147 is required, said step or level break is achieved by supporting upon a row of chairs 143 a length of suitable section 144, said chairs being fixed to formwork 145 by suitable fastenings (not shown) passing through suitable apertures provided in feet 146 of said chairs. Said stepped concrete slab is poured to the desired levels and the higher part 148 of the upper surface of said slab is then finished more or less flush with the upper edge of said section with the lower part 149 of the upper surface of said slab being formed more or less flush with the upper surface of the lower part 150 of said section. In this embodiment, said section optionally takes the form of any suitable of those disclosed herein and may be closed or, as depicted in the figure, open. Said chairs optionally take the form of any suitable of those disclosed herein. In an alternative embodiment, where said section is open as depicted in the figure, a return 151 is optionally provided at its upper edge to better reinforce said step or break in level. In this embodiment, the higher part 148 of the upper surface of said slab is finished more or less flush with the upper surface of said return.

With reference to FIG. 34, in a second embodiment in which a step or break in level of a poured concrete slab 147 is required, said step or level break is achieved by supporting upon a row of chairs 143 a length of suitable section 152, said chairs being fixed to formwork 145 by suitable fastenings (not shown) passing through suitable apertures provided in feet 146 of said chairs. Said section is made more or less in the form of a square U-shape and supports within it a length of wood 153 or other suitable material of suitable width and cut to make a close fit within the interior of said section. In an alternative embodiment (not shown), said length of wood or other material is cut narrower than the interior width of said section and is secured in place against the higher slab side of said section by means of a plurality of suitable wedges. Said stepped concrete slab is poured to the desired levels and the higher part 148 of the upper surface of said slab is then finished more or less flush with the upper edge of said length of wood or other material or to a level marked upon its side. The lower part 149 of the upper surface of said slab is formed more or less flush with the upper surface of the lower part 154 of said section. In this embodiment, when said concrete has cured, said length of wood or other material is removed and the un-embedded side 155 of said section is cut away flush with said lower part of the upper surface of said slab using an angle grinder or similar implement. In an alternative embodiment (not shown), said section is made in the form of a simple L-shape and said length of wood or other material of suitable width is secured to it by suitable, horizontally arranged fastenings passing through it into the vertical part of said section.

In this embodiment (the creation of a step or break in level of a poured concrete building slab), said section optionally takes the form of any suitable of those disclosed herein and may be closed or open. Said chairs optionally take the form of any suitable of those disclosed herein. Chairs formed from a closed cross-sectional shape, for example, round, square, oval or triangular, all with plain, perforated or ribbed sides, are optionally employed where a void in a concrete slab may be tolerated.

In an alternative embodiment (not shown), a sealing compound is applied to the inner surfaces of said sill or hob mould, said sealing compound dispersing into the concrete with which said mould is filled. Said sealing compound preferably takes the form of one such as Xypex®, distributed by Xypex Australia, of 45 Union Road, North Albury, NSW 2641, Australia, in which reactive chemicals diffuse into concrete using water as a migrating medium and crystallise to form a non-soluble filling of pores and capillary tracts in the cured concrete. Said sealing compound is applied in dry form with a suitable binder to the inner surfaces of said sill or hob mould and is activated by the filling of said mould with concrete.

In another alternative embodiment (not shown), said sill or hob mould, immediately following pouring of a building concrete slab, is filled with concrete containing a waterproofing compound.

In another alternative embodiment (not shown), said sill or hob mould side panels are provided with vertical or horizontal fluting, ribbing or doubling or are otherwise treated to provide increased stiffness.

In another alternative embodiment (not shown), the upper and lower edges of said sill or hob mould side panels are rolled, ribbed or folded to provide increased stiffness.

In another alternative embodiment (not shown), channels or other sections are fixed to the upper and lower inner surfaces of said sill or hob mould side panels to provide increased stiffness.

In another alternative embodiment (not shown), transverse stiffeners of the type depicted as 27 in FIG. 6 are welded to the outer or inner surfaces of transverse upper and lower flanges (depicted as 8 and 9 in FIG. 7). Where said sill or hob mould is made from a light metal alloy material, said transverse stiffeners are optionally fixed by cold pressure welding. Where said sill or hob mould is made from a steel alloy material, said transverse stiffeners are fixed by spot welding.

In another alternative arrangement (not shown), the side panels of said chair are effectively made telescopic as depicted in FIG. 7 and the abutting surfaces of said side panels have formed on them complementary, ratchet-type projections which permit telescopic extension but prevent telescopic collapse. In use, said sill or hob mould is temporarily supported from said formwork at the correct height and said chair side panels are then telescopically extended and fixed to said mould to provide sustained support. Should there be a requirement to telescopically collapse said chair side panels, they are removed and physically separated for this purpose.

In another alternative embodiment (not shown), the height of said sill or hob mould on said chair is adjusted by positioning pairs of opposed wedges between them. Slots are provided through said wedges to accommodate a draw bolt which is employed to draw said wedges together or increase their spacing, as appropriate.

In another alternative embodiment (not shown), to minimise the possibility of conflict with reinforcing bar, plate or mesh installed in said formwork, the transverse bottom part of said chair (depicted as 13 in FIG. 1) is deleted and the lower edges of said chair side panels are provided with tabs, flanges of other means for attachment to said formwork.

In another alternative embodiment (not shown), a clearly visible gauge make is provided on the side panels of said chair or said sill or hob mould up to which concrete is filled in the pouring of a building concrete slab.

In another alternative embodiment (not shown), said sill or hob mould is made in a regularly curved planform to meet the needs of a particular architectural situation. In this embodiment, said sill or hob mould construction is of the type described in relation to FIG. 7, said side panels first being separately curved to the correct radius and then joined by transverse or zig-zag-type spacers which are preferably spot welded into place. Said chairs are positioned as required to support said curved mould. In another alternative embodiment (not shown), said sill or hob mould is made in an irregularly shaped planform to suit a particular architectural situation, the method of manufacturing said sill or hob mould being generally as described for that with a regularly curved planform.

In another alternative embodiment (not shown), a plurality of free standing said chairs are distributed over said formwork prior to pouring of a building concrete slab and are employed as level gauges during said pouring.

In another alternative embodiment (not shown), said chairs and said sill or hob moulds are made in ranges of heights and widths to suit a variety of architectural applications.

In the present invention, except where clearly impractical, any feature described in one embodiment should be taken as able to be used in combination with any feature of another embodiment.

1-88. (canceled)

89. Apparatus for creating a step or break in level of a poured concrete building slab, said apparatus comprising a length of section of suitable height and cross-sectional shape supported upon a plurality of discrete chairs which are, in turn, fixed to supporting formwork by suitable fastenings; said chairs being unitary or comprising height-adjustable elements; said section providing level references to which the surfaces of the higher and lower parts of said concrete slab are finished and acting as a riser between the two said surfaces; said section and said chairs being left in place in said concrete slab following its curing.

90. The apparatus of claim 89 in which said section is of an L-shaped cross-sectional shape, the vertical part of said section defining the riser of said step or break in level of said concrete slab; optionally in which said section is of a square, Z-shaped cross-sectional shape, the surface of the higher part of said concrete slab being finished level with the upper surface of the upper horizontal part (return) of said section, the vertical part of said section defining the riser of said step or break in level of said concrete slab and the upper horizontal part (return) providing reinforcement of the edge of said step or break in level; optionally in which said section is made more or less in the form of a flat-bottomed U-shape and supports within it a length of wood or other material; the surface of the higher part of said concrete slab being finished against said wood or other material; the surface of the lower part of said concrete slab being finished level with the upper surface of the lower part of said section; said wood or other material being removed after curing of said concrete slab and the free, un-embedded part of said section being cut away flush with the finished surface of said concrete slab lower part; optionally in which the surface of the higher part of said concrete slab is optionally finished to a level reference marked on the side of said wood or other material; optionally in which said length of wood or other material is cut to be a neat, frictional fit within said section or is made narrower and secured in place within said section by means of wedges; optionally in which said section is made L-shaped and said length of wood or other material is secured to said section by suitable fastenings; optionally in which said section is optionally made with an open or closed cross-section of any suitable shape; optionally in which, where a void in a concrete slab may be tolerated, said chairs are optionally made with a cross-sectional shape which is round, square, oval or triangular and with plain, perforated or ribbed sides.

91. The apparatus of claim 89 in which said section takes the form of an elongated hollow mould, said mould comprising two generally parallel, continuous side panels joined in fixed spatial relationship at their upper and lower edges by spacer elements which permit the entry of concrete from above and the passage of concrete therethrough to said formwork during pouring of said concrete slab; the surface of the higher part of said concrete slab being finished level with the upper surface of said hollow mould, the surface of the lower part of said concrete slab being finished level with the lower surface of said hollow mould; said hollow mould being filled with concrete during pouring of said slab and trowelled off to a level surface, the concrete within said filled mould being contiguous with that of said concrete slab beneath; optionally in which each said chair comprises two narrow, parallel, vertically oriented side panels joined at their lower ends by a transverse bottom part fixed to said formwork, said section or mould being supported in a said chair by a height-adjustable transverse bridge fixed to said chair side panels; optionally in which said transverse bridge is fixed to said chair side panels as required to position said section or said mould at a height to permit finishing of said upper surfaces of said higher and lower parts of said concrete slab at the desired levels.

92. The apparatus of claim 91 in which the upper and lower edges of said mould side panels are turned inwardly through an angle of at least 90 degrees to form upper and lower flanges which act to stiffen said upper and lower edges; optionally in which said mould side panels are joined at their upper edges by a plurality of spacer clips which are narrow (in an axial sense of said mould) and well separated, said clips engaging the upper, outer edges of said mould and being retained in place by tabs formed on said spacer clips engaging the lower surfaces of said side panel upper flanges; optionally in which said mould side panels are joined at the lower edges by a plurality of spacer pieces fixed to the inner edges of said side panel lower flanges; optionally in which said spacer pieces take the form of short cut pieces of tubing tack welded to the inner edges of said side panel lower flanges.

93. The apparatus of claim 89 in which said transverse bridge and said section or said mould side panels are fixed to said chair side panels by suitable fastenings; optionally in which a jig is employed to correctly position said transverse bridge and said section or said mould in said chair prior to the installation of said fastenings; optionally in which the combination of said section and said chairs or said mould and said chairs is set in place and fixed to said formwork as part of the process of setting in place the reinforcing bar of said concrete slab; optionally in which said mould side panels are attached by a hinge arrangement to said lower spacer elements, allowing said mould to be opened out and shipped flat; optionally in which sprigs formed on a fixing plate are passed through complementary apertures in said transverse bottom part of a said chair and driven into said formwork to retain said chair in place.

94. The apparatus of claim 91 in which two intersecting runs of said mould are joined by a joining member comprising side panels having the same height and lateral spacing of those of said mould, the upper and lower edges of said side panels being turned inwardly twice through an angle of 90 degrees to form upper and lower channels having an inner face parallel to said side panels and which act to stiffen said upper and lower edges, transverse spacers being welded to said inner faces to maintain said side panels in fixed spatial relationship; an oblique strap being welded at top and bottom to both parts of said joining member over the line of intersection and doublings being fixed to the inner surfaces of said side panels and extending axially outwards to slidingly engage and overlap the inner surfaces of the ends of runs of said mould to be joined by said joining member; said joining member being supported on a chair comprising a square or equi-armed, L-shaped base plate fixed to said formwork, said base plate supporting two parallel, appropriately positioned pairs of side panels, each said pair of side panels supporting a transverse bridge which, in turn, supports one part of said joining member at an appropriate height above said formwork, said transverse bridge and said joining member being fixed to said side plates with suitable fastenings; optionally in which said joining member is made to accommodate runs of said mould intersecting at a variety of angles.

95. The apparatus of claim 91 in which said mould is made with symmetrical side panels, the upper and lower edges of which are turned through 90° to create upper and lower transverse flanges, said side panels being maintained in fixed spatial relationship by the ends of transverse spacers being turned through an angle of 90 degrees and the turned parts welded to the upper and lower inner surfaces of said side panels; optionally in which said mould is made with symmetrical side panels, the upper and lower edges of which are turned through 90° to create upper and lower transverse flanges, said side panels being maintained in fixed spatial relationship by spacers made in continuous, zigzag-type form with small flats parallel to said mould side panels provided between each angled part, said flats being welded to the upper and lower inner surfaces of said side panels; optionally in which said mould is made in continuous lengths, said side panels being formed up from continuous lengths of flat strip material, straightened and brought together into correct juxtaposition with said continuous, zigzag-type spacers between them, said spacers being spot-welded to said side panels; optionally in which the vertical width of said transverse spacers and said zigzag-type spacers falls in the range 10 millimetres to substantially the same height as said mould; optionally in which said mould is formed up from a continuous length of strip material in a generally U-shaped form and panels of suitable size are punched or otherwise cut out from the lower transverse panel to create voids separated by narrow transverse strips at regular intervals, the upper edges of said side panels of said sill or hob mould being turned through an angle of at least 90 degree to form transverse stiffening flanges.

96. The apparatus of claim 95 in which robotic welding means are employed to fix said spacers to said mould side panels.

97. The apparatus of claim 89 in which said chairs are made with telescopic side panels to permit adjustment of the height of said chairs, said side panels having complementary slotting, a bolt passing through said slotting supporting between said side panels a crush tube, tightening of a nut onto a threaded end of said bolt causing said side panels to be captured between the ends of said crush tube, the head of said bolt and said nut; optionally in which the upper ends of said chair side panels are turned through an angle of 90 degrees to create transverse fixing flanges, said section or said mould being fixed to a said chair by suitable fastenings passing through said section or mould lower transverse flanges aid said chair transverse fixing flanges; optionally in which said fixing flanges formed on the upper edges of said chair side panels are provided with lateral slotting to permit adjustment of the alignment of a said mould on a said chair before being fixed into position.

98. The apparatus of claim 97 in which guide buttons are provided on one of each said telescopic pair of chair side panels, said buttons engaging said slotting and acting to maintain said side panels in alignment during said telescopic adjustment; optionally in which said chair side panels are made telescopic, only one part of each said panel being slotted and said bolt being retained in suitable apertures in the other, un-slotted members; optionally in which separate transverse partitions are provided joining the upper and lower parts of said chair telescopic side panels to maintain said parts in correct lateral juxtaposition, height adjustment screws passing between said partitions being employed to adjust the height of a said chair; optionally in which said height adjustment screws are of the interscrew-type in which a male screw of conventional form with an extended threaded part engages a female (tubular) screw with an extended threaded part, altering the length of said screws (by increasing or decreasing engagement of said male screw with said female screw) acting to increase the height of a said chair and, thereby, the height of said mould above said formwork; optionally in which said screws take the form of long screws of conventional form, the heads of which are rotationally captured at one said partition, the other ends of said screws engaging nuts fixed to the other said partition, rotation of said screws in the appropriate sense acting to increase or decrease the height of said mould above said formwork.

99. The apparatus of claim 91 in which said mould is extruded in a continuous length from a thermoplastic polymer material or light metal alloy material, said extruded section comprising two side panels connected at the lower end by a transverse web which is punched or otherwise cut out to create voids separated by narrow transverse strips at regular intervals, longitudinal rails being provided along the upper and lower edges of said side panels, channels of approximately circular cross-sectional shape being formed in said rails and access to said channels being gained via constricted, upwardly and downwardly directed slots; said chair side panels being made with their upper edges substantially cylindrical with a diameter able to be neatly accommodated within said channels, said mould being fixed to a said chair by forcing of said chair side panel upper edges through said slots to frictionally engage said channels; a closure being made with shallow longitudinal rails along each lower edge, the free edges of which are made substantially cylindrical with a diameter able to be neatly accommodated within said channels, said closure being fixed to said mould by forcing of its said rail edges through said slots to frictionally engage said channels; optionally in which suitable apertures are punched or otherwise cut out from said closure to create voids separated at regular intervals by narrow transverse strips; optionally in which said mould is extruded in a single section, with said side panels connected at their upper and lower ends by transverse webs, both of which are punched or otherwise cut out to create voids separated at regular intervals by narrow transverse strips; optionally in which said chair side panels are made from metal sheet material and their upper edges are made substantially cylindrical by rolling or by fixing a wire along said edges, the diameter of said rolling or said wire being such as to be neatly accommodated within said channels of said mould.

100. The apparatus of claim 91 in which said mould is made in asymmetric cross-sectional form, with one said side panel made flat and the other said side panel shaped to suit a particular application, said shaped side panel optionally being made concave with said mould increasing in width downwardly to suit, for example, the base of a hospital wall in which vinyl floor tiles are curved to pass from the floor surface to the wall surface, the embodiment acting to improve hygiene by eliminating the difficult- to-clean zone normally existing at the junction of a wall with a floor surface; optionally in which the upper edges of said side panels are turned through an angle of 90 degrees to create upper transverse flanges and transverse or zigzag-type spacers are welded to the upper, inner surfaces of said side panels, longitudinally arranged angles being spot-welded to the lower inner edges of said side panels and transverse or zigzag-type being welded to said angles; the lower edge of said curved side panel being extended vertically downwards to create an apron that is embedded in the surface of the lower part of said concrete slab to form a positive moisture barrier.

101. The apparatus of claim 91 in which the lower edge of a said mould side panel is turned through an angle of 90 degrees to create a lower transverse flange, tabs being spot-welded at their lower ends to said side panel at appropriate regular intervals, flats of a zigzag-type spacer abutting said side panel at the positions of said tabs being captured and fixed to said side panel by said tabs being bent downwardly and against said flats; optionally in which the lower edges of said mould side panels are turned inwardly through an angle exceeding 180 degrees to create channels with lipped, constricting edges, the upper edges of said chair side panels being made substantially cylindrical by rolling or by fixing of a wire along said edges, the diameter of said rolling or said wire being such as to be neatly accommodated within said channels, the upper ends of said chair side panels being turned through an angle of approximately 180 degrees, said mould being fixed to a said chair by said chair side panel edges being forced past said constricting edges to be frictionally captured within said channels; optionally in which part of said lower edges of said mould side panels of suitable width is turned inwardly and tightly through an angle of 180 degrees, approximately half of the width of said upturned part then being turned back downwardly through an angle exceeding 180 degrees to create downwardly orientated channels with constricting edges, the upper edges of said chair side panels being made substantially cylindrical by rolling or by fixing of a wire along said edges, the diameter of said rolling or said wire being such as to be neatly accommodated within said channels, said mould being fixed to a said chair by said rolled or wired edges being forced past said constricting edges to be frictionally captured within said channels; optionally in which short, downwardly projecting parts of the lower edges of said mould side panels are double folded to create a plurality of more or less triangular, female sections, short upwardly projecting parts of the upper edges of said chair side panels being double folded to create a plurality of more or less triangular, male sections able to be neatly accommodated within said female sections, said mould being fixed to said chair side panels by said male sections being interdigitated with said female sections, the former then being displaced laterally to enter and be frictionally captured within the latter; optionally in which the ends of transverse spacers fixed to the inner surfaces of said mould side panels are made with downwardly extending parts which are double folded into more or less triangular male or female sections able to be frictionally captured within complementary sections formed on said chair side panel upper edges.

102. The apparatus of claim 91 in which the lower edges of said mould side panels are double folded to form lower transverse flanges with short lengths of upstanding flange formed on their inner ends, the turned ends of transverse spacers or flats of zigzag-type spacers being made with short, inwardly projecting extensions formed on their lower edges, said lengths of upstanding flange being folded down to capture said short lateral extensions, thereby fixing said transverse or zigzag-type spacers to said side panels; optionally in which the lower edges of said mould side panel are turned inwardly through an angle of 90 degrees and approximately half of said turned part is then turned downwardly and outwardly through an angle of 180 degrees to create outwardly orientated attachment channels, the upper edges of said chair side panels being treated in a reciprocal way to create a complementary, inwardly orientated attachment channel, said mould being fixed to a said chair by the engagement of said complementary attachment channels; optionally in which said mould is manufactured in continuous lengths; optionally in which said spacers are made in the form of a continuous sinusoidal curve and are captured at regular intervals by the bending in of said tabs or by spot-welding at the points of contact with said side panels; optionally in which the lower edges of said mould side panels are turned inwardly through an angle of 90 degrees to create lower transverse flanges and the upper edges of said chair side panels are turned inwardly through an angle of 90 degrees to create attachment flanges, said mould being fixed to a said chair by the abutting said lower transverse flange and attachment flange being clamped together by screw means or a plurality of suitably spaced clamps; optionally in which said mould side panels are joined by a plurality of transverse spacers at regular intervals, the turned ends of which are spot-welded to the upper and lower, inner edges of said side panels, such that said mould is suited for production in continuous lengths; optionally in which the lower and upper edges of said mould side panels are turned through two 90 degree folds to form lower and upper transverse flanges each having short upwardly or downwardly directed flanges formed on them, clips being folded over the turned ends of said transverse spacers or flats of said zigzag-type spacers at regular intervals with lateral extensions of said clips being positioned to abut said lower or upper transverse flanges, said clips then being captured by the folding inwardly of said upwardly or downwardly directed flanges, thereby maintaining said mould side panels in fixed spatial relationship.

103. The apparatus of claim 89 in which said section or said mould is supported upon parallelogram mechanisms the structural elements of each of which are pivotally connected, the upper apices of said mechanisms being fixed to said mould and the lower apices being fixed to a baseplate fixed said form work; the intermediate apices of said mechanisms being joined by-transverse bars, and a threaded rod being employed to adjust the relative positions of said transverse bars one to another and, thereby, to precisely adjust the height of said section or said mould; optionally in which a chair to support said section or said mould comprises a base plate to which are fixed two, parallel, threaded supporting rods of suitable length orientated normal to said base plate, parallel slots being provided in said base plate to permit adjustment of the relative positions of said rods; optionally in which said section or said mould is made with a lower transverse panel or said chair is made with a base plate, said transverse panel or said base plate having one or more slots through which extend fixing screws of one or more clamps, said clamps being adapted to engage reinforcing bar beneath said section, said mould or said chair, tightening of a fixing screw in each said clamp simultaneously causing said clamp to grip said reinforcing bar and locking said clamp to said base plate, said slots permitting adjustment of the relative positions of said clamps; optionally in which a chair to support said section or said mould comprises a base plate to which are fixed two, parallel, threaded supporting rods of suitable length orientated normal to said base plate, one or more slotted apertures being provided in said base plate; suitable fastenings passing through said apertures fix said base plate to supporting bars which are, in turn, fixed to reinforcing bars by a variety of fixing means, said slotted apertures permit positional adjustment of said base plate in relation to said supporting bars; optionally in which said chairs comprise a base plate and parallel, threaded supporting rods of suitable length orientated normal to said base plate, one or more slotted apertures being provided in said base plate; suitable fastenings passing through said apertures fix said base plate to said formwork, said slotted openings permit positional adjustment of a said chair prior to tightening of said fastenings; optionally in which a said chair is made with a base plate provided with one or more slotted apertures, fixing screws passing through said apertures supporting spring clips adapted to engage and be frictionally attached to reinforcing bars beneath, tightening of said fixing screws fixing said clips to said base plate and, thereby, fixing said base plate to said reinforcing bars, said slotted apertures permitting positional adjustment of said clips in relation to said base plate; optionally in which a said chair is made with a base plate provided with one or more slotted apertures and threaded rods fixed to said base plate by upper nuts screwably displaced on the threading of said rods against lower nuts, shoulders of said lower nuts engaging said slotted apertures to prevent said nuts from turning during tightening of said upper nuts; the height of a said threaded rod on said base plate being adjustable by screwably displacing said upper and lower nuts on said threaded rods, said slotted apertures permitting adjustment of the relative positions of said rods; optionally in which a said chair comprises a base plate to which are fixed two, parallel, threaded supporting rods of suitable length orientated normal to said base plate, suitable apertures being provided in said base plate to facilitate a flow of concrete therethrough, suitable fixing apertures being provided around the periphery of said base plate to permit the securing of said base plate to reinforcing bar beneath by wire ties; optionally in which a said chair is made with a base plate provided with upstanding edge flanges having longitudinally orientated slotted apertures, large spring clips of the alligator type being supported from said edge flanges by fixing screws passing through said apertures with spacer tubes provided between said edge flanges and said clips, said clips being adapted to engage and grip reinforcing bar adjacent said base plate, said slotted apertures permitting positional adjustment of said clips prior to tightening of said fixing screws, height adjustment of said base plate being effected by rotational displacement of said clips; optionally in which a said chair comprises threaded supporting rods fixed to a base plate, the lower transverse panel of said section or said mould resting upon the flanges of nuts positioned on the upper ends said threaded rods, tubular projections of said nuts passing upwardly through suitable apertures in said lower transverse panel with dished, metal spring washers pressed over said tubular projections to retain said section or said mould in place, the height of said section or said mould being adjustable by screwably displacing said nuts on said threaded rods; optionally in which a said chair comprises a base plate and supporting rods, said rods being made plain and unthreaded with said mould secured in place on said rods by suitable clips frictionally attached to said rods above and below the appropriate surfaces of said section or said mould.

104. The apparatus of claim 89 in which said section or said mould is supported upon a chair formed from a suitable length of metal section folded in a vertical plane, the cross-sectional shape of said folded metal section being selected to provide torsional, transverse and longitudinal stiffness and is optionally approximately Z-shaped, top hat-shaped, W-shaped or V-shaped with wide edge returns, said folded metal section being cut to length by shearing between two dies shaped to match said cross-sectional shape of said folded metal section; optionally in which said folded meta section is optionally cut straight across and welded to said section or said mould or made with a plurality of attachment tabs formed on one or both ends, said attachment tabs being employed, to fix the lower end of a said chair to a base plate and/or its upper end to said section or said mould, suitably positioned slots being punched in said base plate and/or said section or said mould lower transverse panel, said attachment tabs being passed through said slots and bent over flat, twisted through an angle of approximately 90 degrees or welded to secure said folded metal section into place; optionally in which a said chair comprises a folded metal section having telescopically adjustable side panels at its upper end, the lower end of said folded metal section being fixed to a base plate by welding or by a plurality of attachment tabs passed through suitable slots, said base plate being suitably joggled, if necessary, to accommodate said attachment tabs and fixed to said formwork by suitable fasteners, the upper ends of said side panels being turned through an angle of 90 degrees to create transverse fixing flanges, said section or said mould being fixed to said chair by suitable fastenings passing through said section or said mould transverse lower panel and said transverse fixing flanges; vertical slots being provided in said side panels or the sides of said folded metal section to permit sliding height adjustment of said section or said mould when fastenings passing through said slots are loosened; optionally in which said attachment tabs are made in closely-spaced pairs and said folded metal section is fixed to said section, said mould or said baseplate by passing a said pair of attachment tabs through a common slot and then bending them flat in opposed senses; optionally in which a sealing compound is applied to the inner surfaces of said section or said mould, said sealing compound dispersing into concrete placed against said section or with which said mould is filled; optionally in which said sealing compound takes the form of one in which reactive chemicals diffuse into concrete using water as a migrating medium and crystallise to form a non-soluble filling of pores and capillary tracts in the cured concrete, said sealing compound being applied in dry form with a suitable binder to the inner surfaces of said section or said mould and activated by the placing of concrete against said section or the filling of said mould with concrete; optionally in which, immediately following pouring of a said concrete slab, concrete containing a waterproofing compound is placed in the zone adjacent said section or said mould is filled with concrete containing a waterproofing compound.

105. The apparatus of claim 91 in which said mould side panels are provided with vertical or horizontal fluting, ribbing or doubling or are otherwise treated to provide increased stiffness; optionally in which the upper and lower edges of said mould side panels are rolled, ribbed or folded to provide increased stiffness; optionally in which channels or other sections are fixed to the upper and lower inner surfaces of said mould side panels to provide increased stiffness.

106. The apparatus of claim 89 in which said chair side panels are made in a telescopic arrangement, the abutting surfaces of said side panels have formed on them complementary, ratchet-type projections which permit telescopic, extension but prevent telescopic collapse, in use, said section or said mould being temporarily supported from said formwork at the correct height while said chair side panels are telescopically extended to fix said section or said mould at the required height and provide sustained support; optionally in which the height of said section or said mould on said chairs is adjusted by positioning pairs of opposed wedges between the two components, slots being provided through said wedges to accommodate a draw bolt employed to draw said wedges together or increase their spacing, as appropriate; optionally in which, to minimise the possibility of conflict with reinforcing bar, plate or mesh installed in said formwork, the transverse bottom parts of said chairs are deleted and the lower edges of said chair side panels are provided with tabs, flanges of other means for attachment to said formwork; optionally in which a clearly visible gauge mark is provided on the side panels of said chairs or said section or said mould up to which the surface of said concrete is filled or finished during the pouring of said concrete slab; optionally in which said section or said mould is made in a regularly or irregularly curved planform to meet the needs of a particular architectural situation, the side panels of said mould first being separately curved to the correct radii and then joined by transverse or zigzag-type spacers, said chairs being positioned as required to support said curved section or mould; optionally in which said chairs are made unitary or comprising height-adjustable elements; optionally in which said chairs and said sections and said moulds are made in ranges of heights and widths to suit a variety of architectural applications; optionally in which, except where clearly impractical, any feature or features forming part of the present invention is used in combination with any other feature or features; optionally in which the materials used in the making of said chairs, said section or said moulds are any suitable metal alloy or polymer; optionally in which component parts are joined as required using gas welding, electric welding, spot-welding, fusion, pressure welding, adhesives and any form of fastening well known in the art.

107. A method of forming a step or break in level in a poured concrete building slab, said method comprising supporting a length of section of suitable height and cross-sectional shape upon a plurality of discrete chairs which are, in turn, fixed to supporting formwork by suitable fastenings, said chairs being unitary or comprising height-adjustable elements; pouring said concrete slab and finishing the surface of the higher part of said concrete slab level with the upper edge of said section or, optionally, to a lower level against said section or against a length of wood or other material supported in said section; finishing the surface of the lower part of said concrete slab approximately level with the upper surface of the lower part of said section; after curing of said concrete slab, removing the length of wood or other material, where used, and cutting away the free, un-embedded part of said section flush with the finished surface of said concrete slab lower part; and leaving said section and said chairs in place in the cured said concrete slab.

108. A method of forming a step or break in level in a poured concrete building slab, said method comprising supporting an elongated, hollow mould upon a plurality of discrete chairs which are, in turn, fixed to supporting formwork by suitable fastenings; said mould comprising two generally parallel, continuous side panels joined in fixed spatial relationship at their upper and lower edges by spacer elements which permit the entry of concrete from above and the passage there through to said formwork; said chairs being unitary or comprising height-adjustable elements; pouring said concrete slab, filling said mould and finishing the surface of the higher part of said concrete slab level with the upper edge of said mould and the surface of the lower part of said concrete slab level with the lower edge of said mould, the concrete within said filled mould being contiguous with that of said concrete slab beneath; and leaving said mould and said chairs in place in the cured said concrete slab.
